(19) United States
(12) Patent Application Publication
(10) Pub. No.: US 2007/0034096 A1
(43) Pub. Date: Feb. 15, 2007

(54) METHOD AND APPARATUS FOR MAINTAINING AN ELEVATED FOOD TEMPERATURE

(75) Inventors: Grigore Axinte, Bellevue, WA (US); David Crist, Seattle, WA (US); Russell Borgmann, Bellevue, WA (US)

Correspondence Address: Perkins Coie LLP, Suite 800, 607 14th Street, NW, Washington, DC, 20005, US

(73) Assignee: Hyperion Innovations, Inc., Bellevue, WA (US)

(21) Appl. No.: 11/428,306

(22) Filed: Jun. 30, 2006

Related U.S. Application Data
(60) Provisional application No. 60/698,477, filed on Jul. 13, 2005.

(51) Int. Cl. A23C 15/04

(52) U.S. Cl. 99/483

(57) ABSTRACT

The invention relates to an apparatus for warming food. The invention is energy efficient, allowing food to be kept warm for a significant duration while consuming less power than conventional food warmers. This allows the invention to be portable because it is not dependant on 120V AC power. Additionally, the invention provides evenly distributed heat maintaining a high level of appeal for all food in the warmer.

### CROSS-REFERENCE TO RELATED APPLICATION

This application claims priority to and incorporates by reference in its entirety U.S. Provisional Application No. 60,698,477, filed Jul. 13, 2005, titled “METHOD AND APPARATUS FOR MAINTAINING AN ELEVATED FOOD”.

### TECHNICAL FIELD

The following relates to an apparatus and method for providing heat to prepared meals.

### BACKGROUND

Food warming and heat-maintaining trays are particularly useful for occasions when it is desired to maintain food at a heated state for consumption while it is displayed. For example, “sterno flame” server devices are commonly used in banquet halls and cafeteria serving lines to maintain food at a hot temperature for a long period of time. Typically, the food is prepared in a cooking area and then placed into pans that sit above the “sterno flame” for serving. The sterno flame typically is a canister that is ignited to provide heat.

For maintaining casseroles or other types of food at an elevated temperature in the home, electric “hot plates” are often utilized. These trays are conventionally cord-connected to an electric power source and heated to a warming temperature of approximately 200° F. to maintain the temperature of food provided on the top heating surface.

Although conventional “sterno flame” and “hot plate” food warming devices have remained in popular use for decades, there are some disadvantages associated with these products. “Sterno flame” devices tend to provide heat unevenly across the surface. This can cause the food to “dry out” or burn in some areas of the tray, which affects the flavor and overall appeal of the food. Electrical hot plates usually provide consistent heat across the heating surface, but tend to require much electrical energy. For occasions where a hot plate is desired but an AC electrical outlet is not available, it is impractical to use a long extensions cord for an electrical hot plate. Battery-powered hot plates are also available, but these tend to be underpowered or otherwise require frequent battery re-charges.

### SUMMARY

A food warming apparatus is disclosed that includes a heater assembly formed by a plurality of heater segments. At least one of the heater segments includes a semiconductive heater element. The apparatus also includes an electrical power storage source in electrical communication with the heater assembly. A control unit selectively provides power from the electrical power storage source to the heater segments.

The food warming apparatus may include a heater assembly disposed within a body. A surface area above the heater assembly could receive food items or trays. The food warming apparatus optionally has a removable insulating lid. This lid seals the heater's surface area to maintain heat generated by the heater assembly.

The food warmer may be capable of being powered by a power supply. This power supply may be adapted to receive power from the electrical power storage source, an AC adapter, or an automotive battery. The control unit will provide power to the heater assembly from the selected power source.

### BRIEF DESCRIPTION OF THE DRAWINGS

Additional embodiments will be more apparent upon consideration of the following detailed description, taken in conjunction with the accompanying drawings, in which like reference characters refer to like part throughout, and in which:

FIG. 1 is a schematic illustration of a cross-section of a heater assembly for a food warmer apparatus according to an exemplary embodiment of the invention.

FIG. 2 is an illustration of the tracing of a heater for use in a food warmer apparatus in accordance with an exemplary embodiment of the invention.

FIGS. 3A and 3B are schematic illustrations of the architecture of a food warmer apparatus in accordance with exemplary embodiments of the invention.

FIGS. 4A and 4B are illustrations of a multi-functional lid for a food warmer in accordance with an exemplary embodiment of the invention.

FIGS. 5A, 5B, and 5C are illustrations of a multi-functional lid for a food warmer with or without handles in accordance with an exemplary embodiment of the invention.

FIGS. 6A and 6B are illustrations of a multi-functional lid for a food warmer in accordance with an exemplary embodiment of the invention.

FIG. 7 is an illustration of a perspective view of a multi-functional lid for a food warmer in accordance with an exemplary embodiment of the invention.

FIG. 8 is an additional illustration of a perspective view of a heating apparatus in accordance with an exemplary embodiment of the invention.

FIGS. 9A, 9B, 9C, and 9D are illustrations of different sizes and configurations for a food warmer in accordance with exemplary embodiments of the invention.

### DETAILED DESCRIPTION

The following discloses a food warmer that heats up quickly, distributes heat evenly, stays warm for long periods, and consumes a reduced amount of power. This allows the food warmer to be portable and useable when away from conventional 120V AC power.

The food warmer described herein can be made in various sizes and shapes to accommodate different food warming applications. The food warmer could hold, for example, a large family casserole, a stack of plates, a single lunch serving, or be made in any other size that has consumer appeal. The food warmer is designed to disburse the heat evenly throughout the inside of the food warmer and has insulation to lessen heat loss to the outside. The heating element heats up very quickly reducing the total amount of time required to warm food. Because of the heating element's efficiency, operation at elevated temperatures for long periods powered by built-in rechargeable batteries is possible.

In accordance with certain exemplary embodiments, a heater assembly is provided for warming or maintaining food temperature at an elevated level prior to or during food service. The heater assembly is incorporated into a food warmer apparatus that provides evenly distributed heat to, for example, a prepared meal, using any one or combination of sources including but not limited to 120V AC from a standard power outlet or DC power from a battery or an accessory interface jack in a boat or an automobile.

In at least one, the food warmer can provide energy-efficient, battery-powered heating at or above 140° F. for at least two hours for prepared food that is already at an elevated, warm temperature. The heating element of the food warmer may be comprised of a semiconductive foil, such as graphite foil, to provide even, consistent and efficient resistive heating. In another embodiment, the heating surface is divided into a plurality of sections, each containing a heating element, and a control system selectively powers the sections such that heat energy is applied to regions where food is placed. In yet another embodiment, the food warmer accepts both battery power and AC power, and the batteries are charged when the food warmer uses AC power enabling later, portable use.

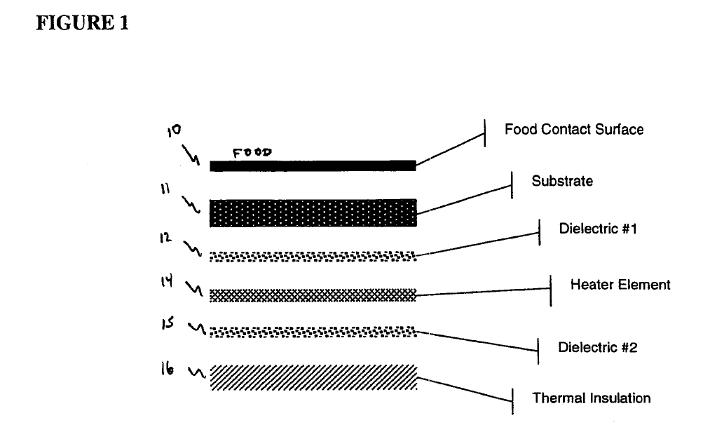

FIG. 1 illustrates a cross-section for an exemplary heating assembly in accordance with an embodiment. Heating element 14 is comprised of a broad area semiconductive material, such as graphite foil or alternatively, graphite fabric, or felt. As a further alternative, the semiconductive foil, fabric, or felt can be made of one or more semiconductive materials instead of or in addition to carbon. The semiconductive foil, fabric, or felt is particularly suitable for use as a heater for a food warmer because it is flat, thin, and compressible. The material tends to heat quickly when provided with electrical energy from a power source and heats uniformly. If one point or area within the material is damaged, broken, torn or punctured, the electrical circuit is still completed, such that heat continues to be created to warm the surface. This stands in marked contrast with a resistance wire heater, which is more vulnerable to failure in this regard.

As shown in FIG. 1, the heater element 14 is surrounded by dielectrics and insulation. More specifically, the heating assembly may include a food contact surface 10 that directly contacts either the food itself (not shown) or a food container (not shown). The food contact surface 10 may be comprised of porcelain or Teflon. In certain embodiments, a food contact surface may not be required.

Beneath the optional food contact surface in FIG. 1 is a substrate 11. Examples of materials for the substrate 11 may include, but are not limited to, glass, steel, aluminum, or a stainless steel. Beneath the substrate 11 and above the heater element 14 is a first dielectric 12, which may be of PSA, porcelain. Teflon, silicone, or other similar materials recognizable to one of ordinary skill in the art. Likewise, a second dielectric 15 is positioned beneath the heating element 14 and can be made of materials similar to first dielectric 12. Finally, thermal insulation 16 may be made from materials such as rigid foam or wood providing additional shaping and structure for the heater assembly.

Certain combinations of materials may be particularly advantageous for the food contact surface, substrate, dielectrics, and thermal insulation. The following table lists some examples of possible material selections for the heated surface assembly:

| | 1 | 2 | 3 | 4 |
|---|---|---|---|---|
| Food Contact Surface | None | Porcelain | Teflon | None |
| Substrate | Glass | Steel | Aluminum | Stainless |
| Dielectric #1 | PSA | Porcelain | Teflon | Silicone |
| Heater Element | Foil | Foil | Foil | Foil |
| Dielectric #2 | PSA | Silicone | PSA | Silicone |
| Thermal Insulation | Rigid Foam | Wood | | |

Differences in the combinations presented above reflect the different conductivity of certain materials, which determines whether a certain type of electrical insulation is required. Those with ordinary skill in the art will recognize and know of such variations.

In some embodiments, the heater element may be configured in a circuitous serpentine fashion of a graphite foil with two electrical contacts. It is noted that, according to various embodiments, the use of a configuration in which the ends of the heating element are in close proximity to each other may be desired, e.g., to facilitate connection to the positive and negative terminals of a power source. Those of ordinary skill in the art will recognize that the particular dimensions and configuration of the heating element being used may be chosen such that specific desired heater resistance requirements are met. More particularly, the length to width aspect ratio of the heater element can be specified as, for example:

$$\frac{length}{width} = ( \frac{( thickness * {volts}^{2} )}{( resistivity * power )} ) .$$

An overall configuration of geometrically straight and parallel semiconductor heating elements functioning electrically in parallel reduces or eliminates heat gradients across the cross section by keeping the current path length substantially constant over the entire length of the heating element.

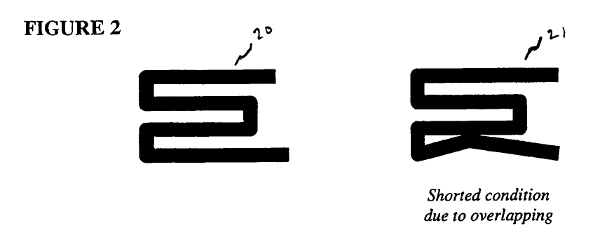

FIG. 2 illustrates the preferred positioning of the heating element 20 to provide the desired resistance heating. If the heating element is not constrained, such that it overlaps as shown in 21, the element will suffer an electrical short-circuit, which affects the calculated and intended resistance for the heating element. To ensure proper spacing, a dielectric (not shown) can be placed between flat strips of the heater element (in addition to above and below the element) to avoid this condition.

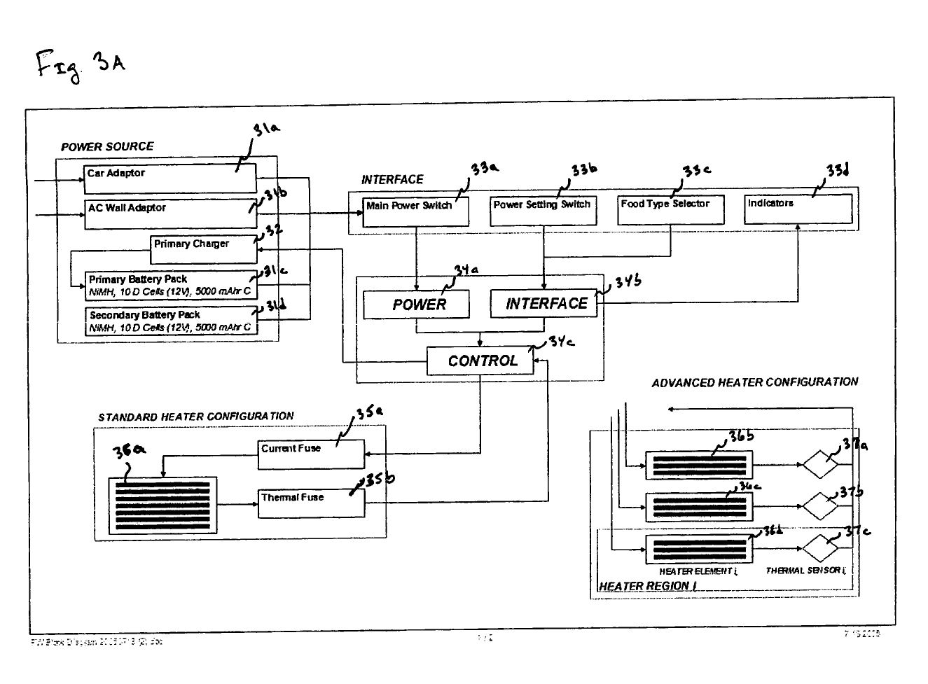

FIG. 3A is a schematic illustration of the architecture for a food warmer in accordance with an embodiment of the invention. This embodiment includes a power source, a user interface, and a heater. As can be seen, examples of the power source for the food warmer include but are not limited to a car adapter 31a, an AC wall adaptor 31b, or a primary and/or secondary battery pack 31c and 31d, or any combination of thereof. If battery power is used, a primary charger 32 can receive electrical energy from the car adaptor 31a or AC wall adaptor 31b power sources simultaneously both to activate the heater element and to charge the primary 31c and secondary 31d battery packs.

As also shown in FIG. 3A, some embodiments can include a user interface. The interface includes a main power switch 33a for switching the unit on and off. Optionally, the interface also includes a power setting switch 33b indicating two or more power levels or temperature ranges. Optionally, the interface may also or alternatively include a food type selector 33c that creates a heating profile specific for the type of food selected. Depending upon the switches and selectors available on the unit, a user display or other type of indicators 33d are available as well.

Also as shown in FIG. 3A, power circuitry 34a and interface circuitry 34b is included corresponding to the power source and the type of available interfaces. This circuitry then feeds control circuitry 34c.

FIG. 3A illustrates two exemplary heater configurations. In one embodiment, depicted as the “standard heater configuration,” heater element 36a receives electrical energy from the control circuitry 34c. The heater element 36a is semiconductive foil, preferably graphite, that is arranged in a serpentine configuration across the heating surface. A current fuse 35a is placed between the control circuitry 34c and the heating element 36a to disconnect the flow of power if there is a short circuit. A thermal fuse 35b is also included to disconnect the flow of power if the temperature of the heater rises above a certain threshold temperature.

In an alternative embodiment, as also shown in FIG. 3A, another heater configuration is shown in which the heater is separated into segments, 36b, 36c, and 36d, each attached to a respective thermal sensor 37a, 37b, and 37c. In accordance with this embodiment, temperature sensors for each region acquire temperature versus time data to create a model of system heat losses, due to conduction, convection, and radiation. Additionally or alternatively, each region's heating element can be pulsed by the control unit 34c to provide additional data on the region's thermal loss profile. The control system can then determine the differences between a large item, such as a casserole tray, that covers an entire heated surface, or one or more smaller items, such as appetizers, breadsticks, etc., that cover only a portion of the surface. Using look-up tables for thermal profiles, a determination is then made as to which one(s) of the heater elements is to be supplied with electrical power to generate heat. With this embodiment, battery life is extended by sensing the thermal demands of items placed atop the heated surface and using the portion of the heater elements where heat is required.

FIG. 3B provides an additional illustration of heater regions in accordance with an alternative embodiment. As shown, there is a plurality of heat sensors 38a-e, each corresponding to a respective heating element 39a-e located in different sections of the heated surface (shown as a plan view). Depending upon where food is placed upon the heating surface, one or more of the heating elements is “turned on” to receive power and provide heating. For those areas where no food is placed upon the surface, the corresponding heat sensor detects a “no food condition” and signals the control circuitry to not provide electrical power to that area.

Additional embodiments may include a multi-functional lid provided to connect with the food warmer helping to prevent spills and to provide additional heat-retaining capabilities, thus reducing the amount of electrical power required to maintain the food at the desired elevated temperature. This is particularly useful for embodiments that operate using battery power, where the voltage required to provide adequate heat to the food warmer is substantially compromised.

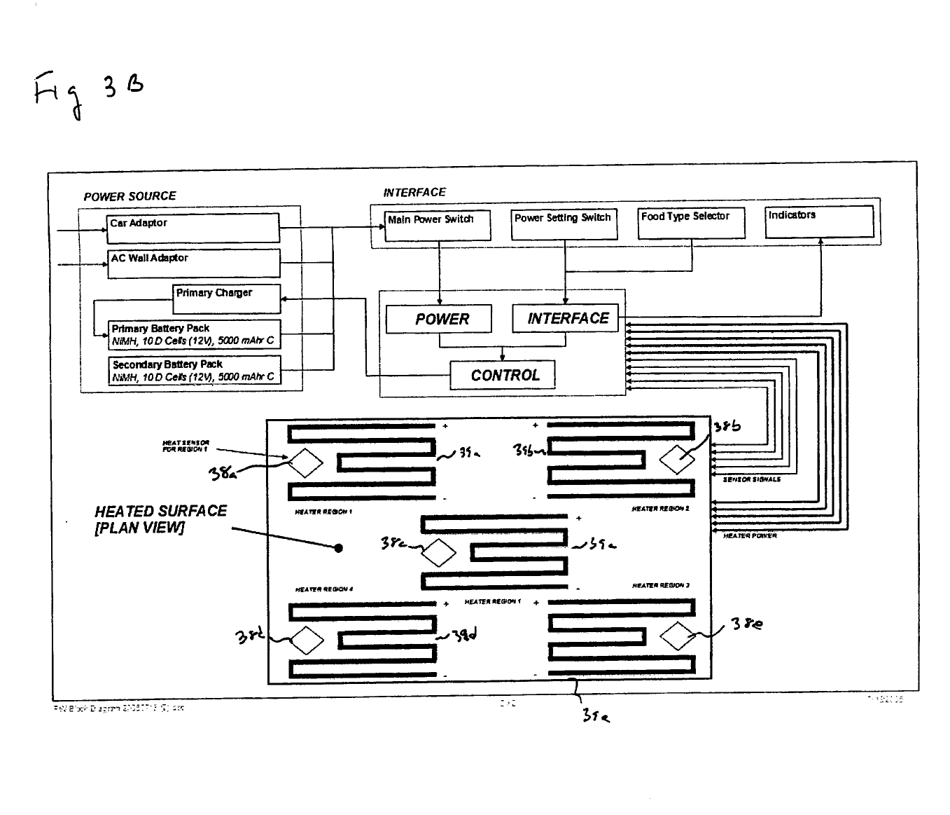

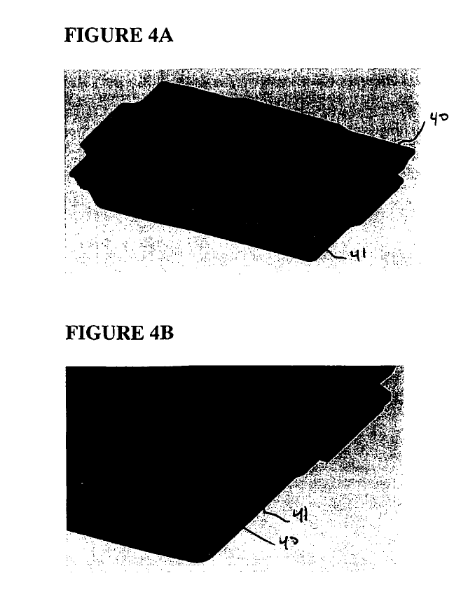

FIGS. 4A and 4B illustrate a multi-functional lid 40 in accordance with an embodiment of the invention. As can be seen, the lid 40 fits atop a Pyrex dish 41 that is utilized with the food warmer. The lid is preferably comprised of silicone. Advantages of utilizing a silicone material are that it has high thermal strength, it is flexible and is a food grade material, and it can be pre-molded for a certain size.

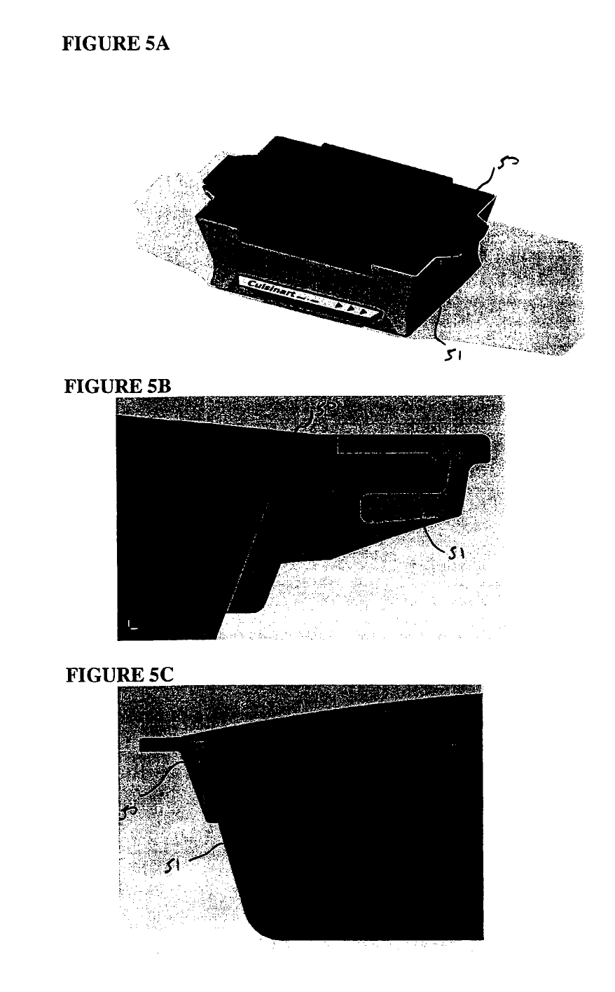

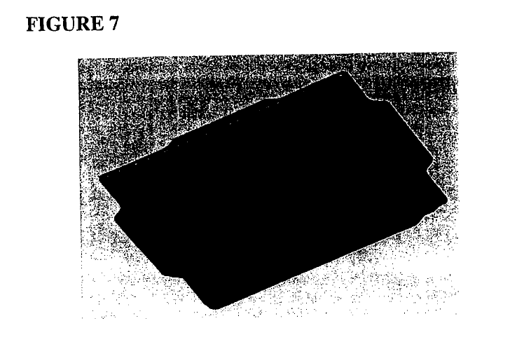

As shown in FIGS. 5A, 5B, and 5C, the multi-functional lid 50 can be used to seal the food warmer 51 itself. As shown in FIGS. 5B and 5C, the lid can be molded so as to enclose the handles of the warmer 51 or a Pyrex dish so as to keep the handles cool to the touch and to provide an effective seal to maintain heat insulation. FIG. 7 is a perspective view of a pre-molded lid, including grippers.

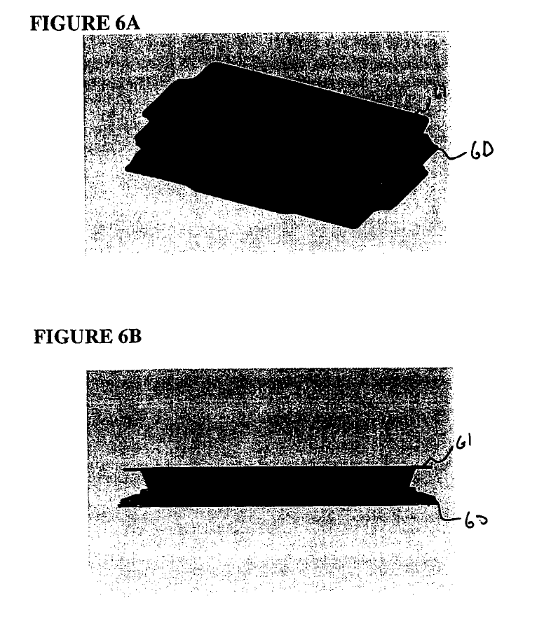

FIGS. 6A and 6B illustrate that the lid 60 can additionally be used as a tray for the Pyrex dish 61, so as to protect the table surface for the dish. As an additional benefit, this provides thermal insulation for the bottom of the Pyrex dish while the dish is used for serving.

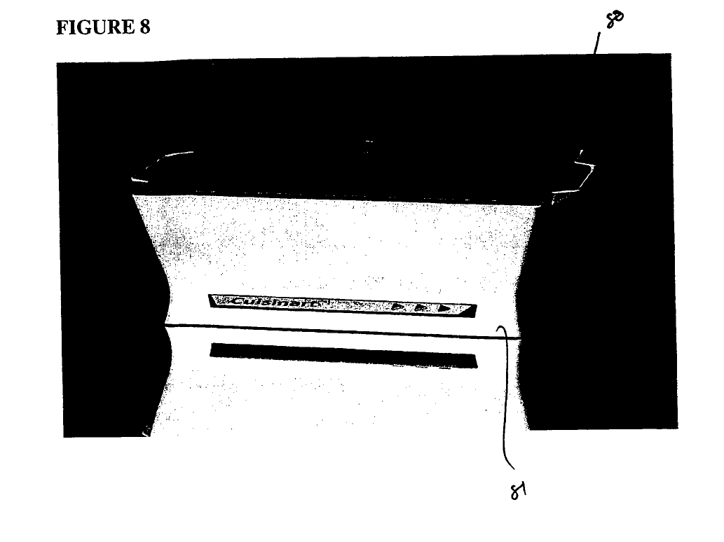

FIG. 8 illustrates the use of a silicon lid 80 with a food warmer 81. As can be seen, the lid completely encloses the top of the food warmer to provide thermal insulation, thereby improving heating efficiency for the food warmer 81 to utilize less battery power for maintaining an elevated food temperature.

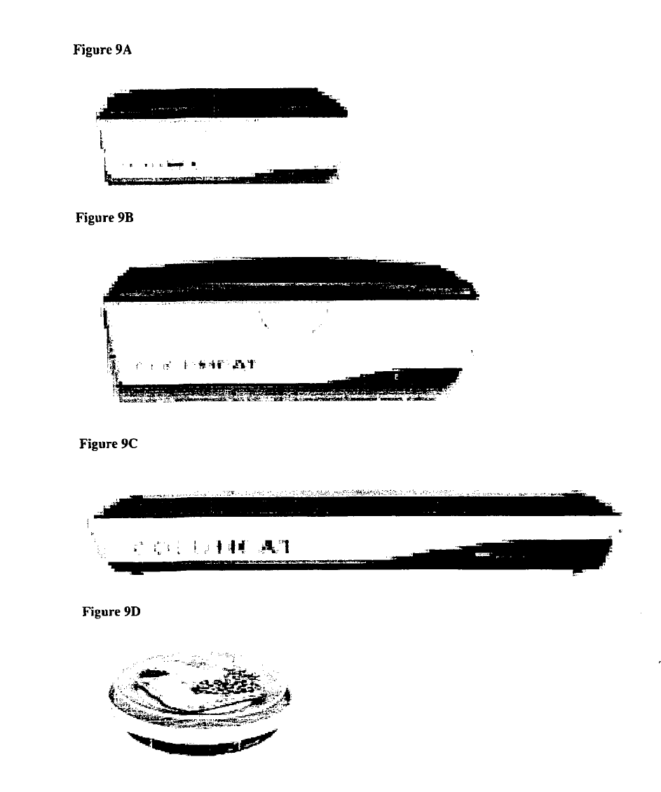

FIGS. 9A-D are exemplary of possible sizes and configurations for the food warmer. FIG. 9A illustrates a single serving size and FIG. 9B a larger casserole size for a family to share. FIG. 9D illustrates an alternative configuration that could be used to heat a single serving that has already been plated or to warm plates prior to serving a meal.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A food warming apparatus, comprising:
a heater assembly formed by a plurality of heater segments, at least one of which including a semiconductive heater element;
an electrical power storage source in electrical communication with the heater assembly; and
a control unit for selectively providing power from the electrical power storage source to the heater segments.

2. The apparatus of claim 1, further comprising at least one sensor associated with each respective heater segment for automatically triggering a heater segment on or off.

3. The apparatus of claim 2, wherein at least one sensor is a thermal sensor.

4. The apparatus of claim 3, wherein the control unit receives input from sensors associated with the heater segments, and the control unit determines which segments are located beneath a food item placed upon portions of the heater assembly.

5. The apparatus of claim 1, wherein the semiconductive heating element is comprised substantially of graphite.

6. The apparatus of claim 5, wherein the semiconductive heating element is comprised substantially of graphite foil.

7. A food warming assembly, comprising:
a heater assembly disposed within a body;
a surface area disposed above the heater assembly for receiving food items or trays;
an electrical power storage source in electrical communication with the heater assembly; and
a removable flexible insulating lid disposed above the surface area for sealingly covering the surface area to maintain heat generated by the heater assembly.

8. The food warming assembly of claim 7, wherein the lid is comprised of silicone.

9. The food warming assembly of claim 7, further comprising at least one carrying handle attached to the body, wherein the lid is molded to enclose the at least one carrying handle.

10. The food warming assembly of claim 7, wherein the lid is shaped such that, when removed from the surface area, the lid provides an insulating tray upon which the food warming assembly can be placed.

11. The food warming assembly of claim 7, wherein the electrical power storage source is disposed within the body.

12. A food warmer, comprising:
a heater assembly;
an electrical power storage source;
a power supply in electrical communication with the heater assembly and adapted to selectively receive power from the electrical power storage source, an AC adapter, or an automotive battery;
a control unit for receiving a power source selection and providing power to the heater assembly from the selected power source.

13. The food warmer of claim 12, wherein the heater assembly is formed by a plurality of heater segments, and the control unit for selectively provides power to the heater segments.

14. The food warmer of claim 13, further comprising at least one sensor associated with each respective heater segment for automatically triggering a heater segment on or off.

15. The food warmer of claim 14, wherein the control unit receives input from sensors associated with the heater segments, and the control unit determines which segments are located beneath a food item placed upon portions of the heater assembly.

16. The food warmer of claim 12, wherein the heater assembly includes at least one heater element comprised substantially of a semiconductive material.

17. The food warmer of claim 16, wherein the semiconductive material is comprised substantially of graphite.

18. The food warmer of claim 17, wherein the semiconductive material is comprised substantially of graphite foil.

19. The food warmer of claim 17, further comprising a removable insulating lid disposed above the heater assembly for sealingly covering a surface area disposed above the heater assembly to maintain heat generated by the heater assembly.

20. The food warmer of claim 19, wherein the removable insulating lid is comprised of silicone.
